(19) United States
(12) Patent Application Publication
(10) Pub. No.: US 2025/0189778 A1
(43) Pub. Date: Jun. 12, 2025

(54) ILLUMINATION OPTICAL MODULE, IMAGING SYSTEM, AND IMAGE PROCESSING METHOD USING THE SAME

(71) Applicant: Samsung Electronics Co., Ltd., Suwon-si (KR)

(72) Inventors: Donggun LEE, Suwon-si (KR); Juntaek OH, Suwon-si (KR); Jinwoo AHN, Suwon-si (KR); Taejoong KIM, Suwon-si (KR); Eunsoo HWANG, Suwon-si (KR)

(73) Assignee: Samsung Electronics Co., Ltd., Suwon-si (KR)

(21) Appl. No.: 18/772,906

(22) Filed: Jul. 15, 2024

(30) Foreign Application Priority Data
Dec. 8, 2023 (KR) 10-2023-0177801

(51) Int. Cl. G02B 21/06; G02B 21/36

(52) U.S. Cl. CPC G02B 21/06; G02B 21/361

(57) ABSTRACT

An illuminating optical module according to an embodiment transmits a beam irradiated from a light source module to a sample, and may include: a first lens that receives a beam from the light source module; a second lens that receives the beam from the first lens; a field stop that is disposed between the first lens and the second lens and adjusts the amount of beam transmitted to the second lens; a third lens that transmits the beam transmitted from the second lens to the sample; and an aperture stop that is disposed on a path of the beam passing between the second lens and the third lens and adjusts a size of numerical aperture (NA), wherein the aperture stop may make the beam transmitted to the sample have the same NA in all parts of a field of view (FOV).

### CROSS-REFERENCE TO RELATED APPLICATION

This application claims priority to and the benefit of Korean Patent Application No. 10-2023-0177801 filed in the Korean Intellectual Property Office on Dec. 8, 2023, the entire contents of which are incorporated herein by reference.

### BACKGROUND OF THE INVENTION

### (a) Field of the Invention

Inventive concepts relate to an illuminating optical module, an image system, and image processing methods using the same.

### (b) Description of the Related Art

As the circuit integration of semiconductor wafers has improved, the size of defects occurring during, for example, lithography processes has also decreased. Accordingly, fine-sized defects or particles, which previously may not have been considered problematic or substantially problematic, may cause significant or fatal performance degradation. Accordingly, it is important to quickly and accurately detect defects that may occur during, for example, lithography processes.

A method using an optical microscope has a merit of being able to conduct an inspection at a relatively high speed compared to other inspection devices without causing a damage or substantial damage to an inspection object. However, there may be a drawback of, for example, low resolution depending on an optical diffraction limit.

In order to improve, for example, low resolution, a short wavelength needs to be used and a numerical aperture (NA) of the optical system needs to be made large. However, when an extremely short wavelength is used, it may cause various limitations in the configuration of the optical system, thereby causing damage to an inspection region.

For example, when increasing the detection limit, for example numerical aperture NA, in a conventional imaging optical system, there is a problem that the size of the equipment itself increases and production efficiency decreases.

### SUMMARY OF THE INVENTION

Example embodiments of the inventive are described to address the above problems, and an illuminating optical module, an image system, and an image processing method using the same are provided to irradiate a beam with the same numerical aperture (NA) in the entire field of view (FOV) by an illuminating optical module by disposing an aperture stop at a focal distance (for example, combined focal distance or effective focal length) of two lenses disposed within the illuminating optical module.

In addition, and an illuminating optical module, an image system, and an image processing method using the same are provided increase sensitivity of a signal to reduce or prevent signal distortion due to surrounding structures by securing a high spatial vibration frequency signal.

An illuminating optical module according to some example embodiments is configured to transmit a beam irradiated from a light source module to a sample, and may include: a first lens configured to receive a beam from a light source module; a second lens configured to receive the beam from the first lens; a field stop between the first lens and the second lens and configured to adjust the area of the beam transmitted to the second lens; a third lens configured to transmit the beam transmitted from the second lens to a sample; and an aperture stop that in a path of the beam and between the second lens and the third lens, the aperture stop configured to adjust a size of a numerical aperture (NA), wherein the aperture stop may be configured to the beam transmitted to the sample have a same NA in all parts of a field of view (FOV).

An image system according to some example embodiments may include: a light source module configured to irradiate a beam; an illuminating optical module that includes a field stop, an aperture stop, and a plurality of lenses, and configured to make the beam irradiated from the light source module have a same numerical aperture (NA) in all parts of a field of view (FOV) and to irradiate the beam to the sample; a focusing optical module configured to collect a beam reflected by the sample and to transmit the collected beam to a measuring module, wherein the measuring module is configured to measures a signal by using the beam transmitted from the focusing optical module.

According to example embodiments, it is possible to acquire signals for the sample structure by improving resolution and improve uniformity of the acquired signal by allowing a beam with the same NA to be irradiated to the sample in all parts of the FOV through the illuminating optical module.

### BRIEF DESCRIPTION OF THE DRAWINGS

FIG. 1 is provided for description of a limit in a structure measurement device using a conventional optical system.

FIG. 2 is provided for description of a limit of the structure measurement device using the conventional optical system.

FIG. 3 is illustrates an image system including an illuminating optical module according to an some example embodiments.

FIG. 4 is illustrate an image system including an illuminating optical module according to some example embodiments.

FIG. 5 illustrates a configuration of an image system including an illuminating optical module according to some example embodiments.

FIG. 6 is illustrates the effect of an image system including an illuminating optical module according to some example embodiments.

FIG. 7 illustrates effects of an image system including an illuminating optical module according to some example embodiment.

FIG. 8 illustrates effects of an image system including an illuminating optical module according to some example embodiments.

FIG. 9 illustrates effects of an image system including an illuminating optical module according to some example embodiments.

FIG. 10 illustrates effects of an image system including an illuminating optical module according to some example embodiments.

FIG. 11 illustrates effects of an image system including an illuminating optical module according to some example embodiments.

FIG. 12 illustrates effects of an image system including an illuminating optical module according to some example embodiments.

FIG. 13 illustrates effects of an image system including an illuminating optical module according to some example embodiments.

FIG. 14 illustrates effects of an image system including an illuminating optical module according some example embodiments.

### DETAILED DESCRIPTION OF THE EMBODIMENTS

Hereinafter, example embodiments of example embodiments will be described clearly and in detail to such an extent that a person of an ordinary skill in the technical field of the present disclosure may easily perform the present disclosure. Inventive concepts may be implemented in several different forms and are not limited to the example embodiments described herein.

In order to clearly describe the present disclosure, parts without explanation or relationship may be omitted, and the same reference sign may be used, for identical or similar components throughout the specification.

In addition, the size and thickness of each component shown in the drawing are arbitrarily shown for better understanding and ease of description, and thus inventive concepts are not necessarily limited to what is shown. In the drawings, the thickness of layers, films, panels, regions, etc., are exaggerated for clarity. In addition, in the drawings, the thicknesses of some layers and regions are exaggerated for better understanding and ease of description.

Throughout this specification and the claims that follow, when it is described that an element is “coupled” to another element, it includes not only “directly connected”, but also “indirectly connected” between other members. In addition, unless explicitly described to the contrary, the word “comprise”, and variations such as “comprises” or “comprising”, will be understood to imply the inclusion of stated elements but not the exclusion of any other elements.

It will be understood that when an element such as a layer, film, region, or substrate is referred to as being “on” another element, it can be directly on the other element or intervening elements may also be present. In contrast, when an element is referred to as being “directly on” another element, there are no intervening elements present. It will be understood that when an element such as a layer, film, region, or substrate is referred to as being “on” another element, it can be directly on the other element or intervening elements may also be present.

Further, throughout the specification, the phrase “on a plane” means viewing a target portion from above, and the phrase “on a cross-section” means viewing a cross-section formed by vertically cutting a target portion from the side.

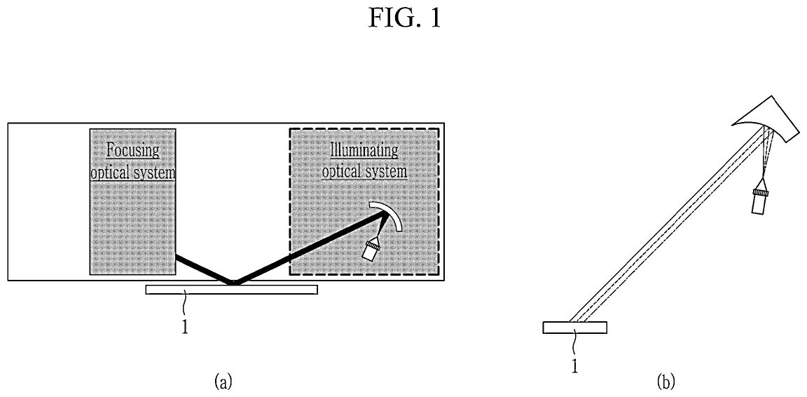

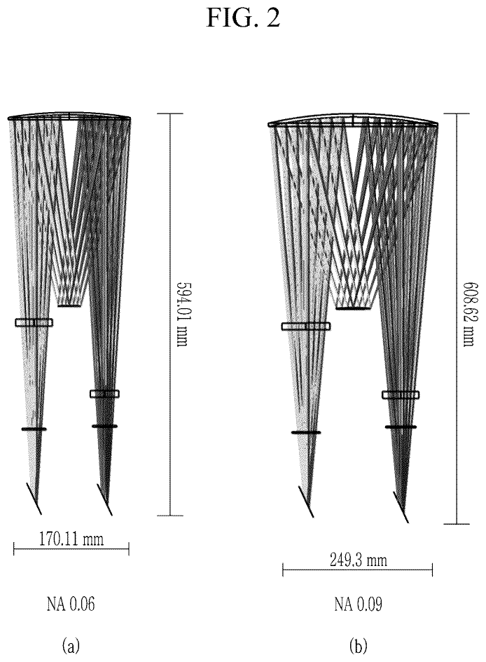

FIG. 1 illustrates of a limit in a structure measurement device using a conventional optical system, and FIG. 2 illustrates of a limit of the structure measurement device using the conventional optical system.

FIG. 1(a) illustrates a conventional structure measurement device using a focusing optical system and an illuminating optical system, and FIG. 1(b) illustrates the illuminating optical system transmitting a beam to a sample 1 among configurations shown in (a).

First, as shown in FIGS. 1(a) and (b), in a process of measuring a structure of, for example, the sample 1 placed between the illuminating optical system and the focusing optical system using a structure measurement device using a conventional optical system, a collimated light illuminating optical system was used for image processing of a large area.

The collimated light illuminating optical system aims to deliver a broad and uniform beam to the sample 1, but each lighting component delivered from the collimated light illuminating optical system is irradiated to the sample 1 with no or small numerical aperture (NA), thereby resulting in low optical resolution.

In other words, the conventional art may extract signals from a wide area of the sample 1 using collimated light illumination, but there are limitations in detecting dense structural signals due to the limitations of the NA of the collimated light illumination. Accordingly, the structural signals measured from the sample 1 may be affected by the surrounding structures, resulting in a decrease in the sensitivity of the measurement.

In more detail, when an extremely short wavelength is used, there may be many limitations in the configuration of the optical system, causing damage to an inspection region, and in a long wavelength region, a distorted signal may be obtained due to limitations in optical resolution. Accordingly, even if the target sample 1 has the same structure, a difference occurs in the measured value depending on the structure or structures surrounding the sample 1.

FIGS. 2(a) and (b) are provided for description of a structure measurement device using a conventional focusing optical system, and show a path along which a beam is transmitted inside the focusing optical system.

The focusing optical system serves to create an image by imaging the beam transmitted (for example, reflected) from the sample 1. The focusing optical system may only detect an NA below a certain specification.

When the above specific NA is referred to as a limit NA, the focusing optical system may only measure structural components below the limit NA, and thus there is a limit in increasing resolution through the focusing optical system.

In increasing the limit NA, there is a problem that the facility size of the focusing optical system itself needs to be significantly increased and thus the efficiency of a method of increasing resolution using a substantially focusing optical system may not be high.

FIG. 2(a) shows a case in which the limit NA is 0.06, and FIG. 2(b) shows a case in which the limit NA is 0.09. The order in which the beam moves in FIGS. 2(a) and (b) is the same. However, when the limit NA is increased as shown in FIG. 2(b), the path along which the beam moves within the focusing optical system needs to be wider, and thus a space occupied by the focusing optical system needs to be wider.

Accordingly, a technology is desired or needed to increase the sensitivity of the signal to reduce or prevent signal distortion due to surrounding structures by securing a high spatial vibration signal without increasing the volume occupied by the focusing optical system.

Hereinafter, in order to address, for example, the above problem, an illuminating optical module 200, an image system 10 including the same, and an image processing method using the same for irradiating a beam with the same NA in the entire FOV to the sample using the Scheimpflug condition and a Telecentric condition will be described in more detail.

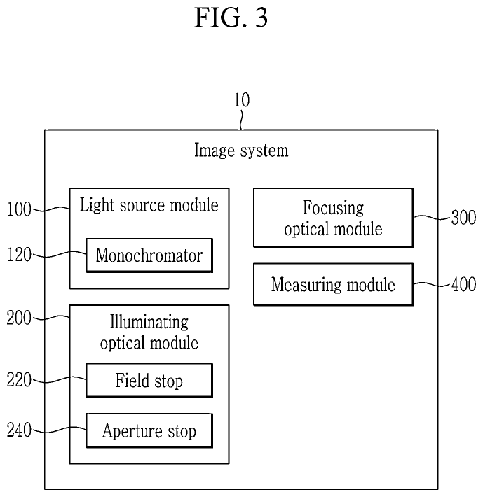

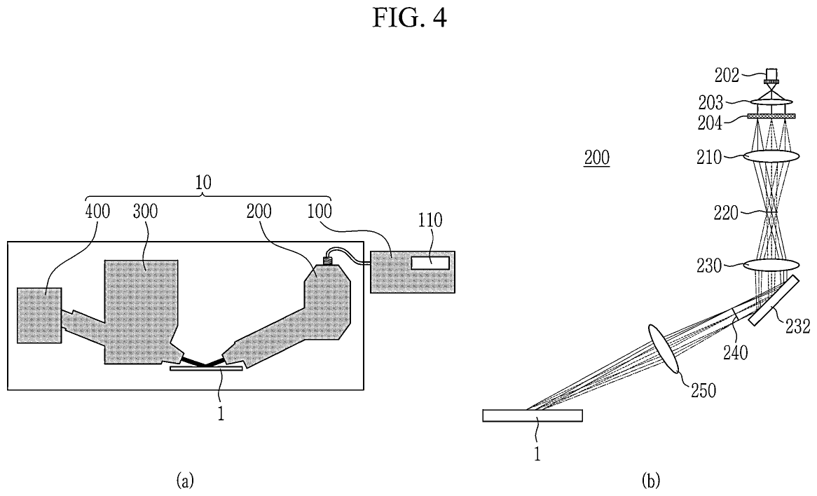

FIG. 3 illustrates of an image system including an illuminating optical module according to some example embodiments, FIG. 4(a) illustrates of an image system including an illuminating optical module according to some example embodiments, and FIG. 4(b) shows a path through which a beam moves in the illuminating optical module according to some example embodiments.

First, as shown in FIG. 3 and FIG. 4(a), the image system 10 according to some inventive concepts may include a light source module 100 irradiating a beam from the light source 110, an illuminating optical module 200 that irradiates the beam irradiated from the light source module 100 to the sample 1, a focusing optical module 300 that collects the beam reflected from the sample 1 and transmits the collected beams to the measuring module 400, and a measuring module 400 that measures a signal from the beam transmitted from the focusing optical module 300.

The light source module 100 may include a monochromator 120. The monochromator 120 filters the beam irradiated from the light source 110 to a desired wavelength, converts it into monochromatic light, and inputs the monochromatic light into the illuminating optical module 200.

The beam irradiated from the light source 110 of the light source module 100 may be, for example, white light. The light source 110 may include, for example, a laser or laser source (for example, a pump source), a plasma or plasma source (for example, a xenon flashlamp), a light emitting diode (LED), and the like, and may be a combination of these depending on example embodiments, but example embodiments are not limited thereto.

FIG. 4(b) shows a path through (for example, “along”) which the beam may moves in the illuminating optical module 200 according to some example embodiments, and the illuminating optical module 200 may include an optic fiber 202 that collects the beam transmitted to the illuminating optical module 200 by the light source module 100 and transmits the collected beam to a first lens 210, a collimating lens 203 that changes the beam transmitted from the optic fiber 202 into a collimated beam, and a diffusion portion 204 that diffuses the beam transmitted from the collimating lens 203 and transmits it to the first lens 210. The diffusion portion 204 may include, for example, at least one of a diffuser and a grating, but example embodiments are not limited thereto.

The illuminating optical module 200 may include, for example, the first lens 210 that receives the beam from the light source module 100, a second lens 230 that receives the beam from the first lens 210, a field stop 220 that is disposed between the first lens 210 and the second lens 230 and adjusts the amount of light transmitted to the second lens 230 (by, for example, adjusting the area of the beam), a third lens 250 that transmits the beam received from the second lens 230 to the sample 1, and an aperture stop 240 that is disposed on the path of the beam passing between the second lens 230 and third lens 250 adjusts the size of a numerical aperture (NA) of the beam transmitted to the third lens 250, but example embodiments are not limited thereto.

According to some inventive concepts, the illuminating optical module 200 uses an aperture stop 240 such that the beam irradiated from the light source module 100 has the same NA in all parts of a field of view (FOV) over a large area (for example, of the sample) and the irradiated beam having the same NA is irradiated to the sample 1. First, the aperture stop 240 will be described.

The beam may have the same NA in all parts of the FOV by placing the aperture stop 240 at a specific position, and the aperture stop 240 according to some inventive concepts may be disposed at a focal distance (for example, combined focal distance or effective focal length) of the second lens 230 and third lens 250 arranged within the illuminating optical module 200.

In order to irradiate a beam with the same NA in all areas of the FOV, central rays of the beam in all areas need to be arranged parallel with the optical axis (Telecentricity). For such a purpose, the aperture stop 240 may be placed where the central rays passing through the second lens 230 meet at the focus position.

From the position where the aperture stop 240 is placed, the third lens 250 is placed at a position moved by (for example, determined by) a focal distance of the third lens 250, and the beam passes through the third lens 250 and the central rays thereof travel parallel to the optical axis to form an FOV on the sample plane.

Eventually, the illuminating optical module 200 in some inventive concepts may secure the above telecentricity condition by adjusting the position of the aperture stop 240 disposed between the second lens 230 and the third lens 250. In addition, accordingly, beams having various components may have the same NA (for example, in all parts of an FOV) as they pass through the aperture stop 240 disposed between the second lens 230 and the third lens 250.

In the overall beam path in FIG. 4(b), the beam diffused in the diffusion portion 204 passes through the first lens 210 and is collected in the field stop 220 placed at the focal distance (for example, combined focal distance or effective focal length) of the first lens 210 and the second lens 230 between the first lens 210 and the second lens 230 and then spread out again to head to second lens 230.

For example, the first lens 210 collects the beam transmitted from the light source module 100 (specifically, the beam diffused from the diffusion portion 204) and transmits the collected beam to the field stop 220, and the field stop 220 adjusts the amount of the beam (for example, area of the beam or the amount of light of the beam) and transmit the adjusted beam to the second lens 230. The second lens 230 may collect the (adjusted) beam received from the field stop 220 and transmit it to the aperture stop 240.

The beam passing through the second lens 230 is gathered again at the aperture stop 240 and then directed to the third lens 250, and as shown in FIG. 4(b), a mirror 232 that changes the path of the beam passing through the second lens 230 may be further included between the second lens 230 and the aperture stop 240.

The beam reflected from the mirror 232 and gathered at the aperture stop 240 spreads again while heading toward the third lens 250, and the beam directed to the third lens 250 is gathered again while passing through the third lens 250 and may be transmitted to the sample 1.

The aperture stop 240 controls the NA size of the beam received from the second lens 230 and transmits the beam to the third lens 250, and the third lens 250 may collect the beam received from the aperture stop 240 and transmit to the sample 1.

In some inventive concepts, the aperture stop 240 serves to control the NA size of the transmitted beam, and beams with various components may have the same NA while passing through the aperture stop 240 placed between the second lens 230 and the third lens 250 by adjusting a position of the aperture stop 240 disposed between the second lens 230 and the third lens 250.

Depending on embodiments, a shutter that can block the beam path may further be included.

Since the aperture stop 240 adjusts the NA of the beam and the field stop 220 adjusts the amount (for example, area) of transmitted beams such that the illuminating optical module 200 according to some inventive concepts can irradiate beams with the same NA in the entire FOV.

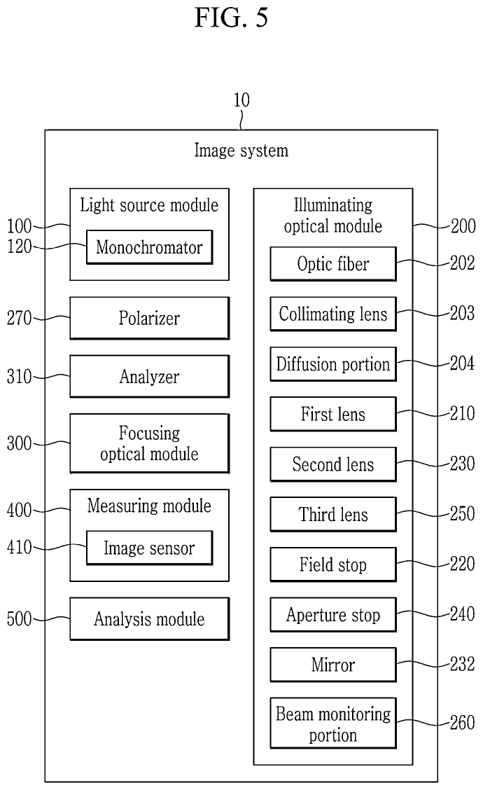

FIG. 5 illustrates of a configuration of an image system including an illuminating optical module according to some example embodiments.

FIG. 5 shows an illuminating optical module 200 according to some example embodiment of some inventive concepts, and the illuminating optical module 200 shown in FIG. 5 may have a structure in which some components may further be included in the illuminating optical module 200 described in FIG. 4.

The illuminating optical module 200 may further include a polarizer 270 that polarizes a beam emitted from a third lens 250. The polarizer 270 controls a polarization component of the beam and linearly polarizes the beam transmitted from the third lens 250 such that the beam can be irradiated to a sample 1 at a specific angle of incidence (AOI). Here, the AOI may within a range of, for example, about 0 to about 90 degrees, but example embodiments are not limited thereto.

The above AOI may be selectively set by a user.

According to some example embodiments, the polarizer 270 is disposed in the path of the beam transmitted from the illuminating optical module 200 to the sample 1, and may be disposed between the illuminating optical module 200 and the sample 1 outside of the illuminating optical module 200.

In addition, the polarizer 270 may be placed between the sample 1 and a focusing optical module 300 to adjust a polarization state of the beam reflected from the sample 1 and transmitted to the focusing optical module 300.

Depending on example embodiments, a beam monitoring portion 260 that monitors the beam transmitted within the illuminating optical module 200 may further be included.

In addition, an analyzer 310 that adjusts a polarization component of a beam may further be included between the sample 1 and the focusing optical module 300, and the analyzer 310 according to some inventive concepts serves to change the beam transmitted from the sample 1 to specific linear polarization properties.

The focusing optical module 300 serves to image (for example, form an image using) the beam reflected and/or scattered from the sample 1 to a measuring module 400. In more detail, the focusing optical module 300 serves to form an image by imaging a plurality of beams incident on a FOV of a large area (for example, of the sample) at each point.

In the above, it is described as a beam incident on the FOV, but the beam incident on the FOV of a substantially large area may correspond to a plurality of beams. Accordingly, in some inventive concepts, the illuminating optical module 200 may transmit a plurality of beams, each beam with the same NA in all parts of the FOV, to the sample 1. The plurality of beams transmitted in such a way may be transmitted (for example reflected and/or scatted) from the sample 1 to the focusing optical module 300, and each beam is imaged into a plurality of points within a limit NA of the focusing optical module 300, and each point may be gathered to form an image.

In a conventional art, in order to increase the above limit NA, the size of the focusing optical module 300 needs to be increased. In contrast, in the case of the image system 10 according to some present inventive concepts, there is a difference in that rather than increasing the limit NA of the focusing optical module 300, the illuminating optical module 200 increases the beam transmitted to the focusing optical module 300 to the same NA in the area.

The image system 10 according to some inventive concepts includes a measuring module 400 that measures signals from a plurality of beams transmitted from the focusing optical module 300, and the measuring module 400 may include an image sensor 410.

The illuminating optical module 200 transmits a plurality of beams with the same NA in all parts of the FOV to the sample 1, and the focusing optical module 300 receives the plurality of beams. Next, the image sensor 410 measures the plurality of beams transmitted from the focusing optical module 300, and to this end the image sensor 410 may be a sensor consisting of a plurality of pixels.

In addition, an analysis module 500 that analyzes the signal measured by the measuring module 400 may further be included.

An image processing method according to some inventive concepts may include image processing using the image system 10 according to some inventive concepts, the aperture stop 240 included in the illuminating optical module 200 to adjust the NA size of the beam, and the field stop 220 to adjust the amount (for example, area) of the beam, allowing a beam of the same NA to be transmitted to the entire FOV without increasing the size of the focusing optical module 300.

Accordingly, signal sensitivity may be increased by reducing or preventing signal distortion, due to surrounding structures, by securing a signal with a high spatial vibration frequency, and the signal may be uniformly measured in a wide area.

The image processing method according to some inventive concepts may include irradiating a beam by (for example, using) the light source module 100 (S100), and making the beam irradiated from the light source module 100 have the same NA in all parts of the FOV by the illuminating optical module 200 and irradiating the beam (having the same NA is all parts of the FOV) to the sample 1 (S200). In addition, the image processing method may include collecting the beam transmitted from (for example, reflected or scattered by) the sample 1 and transmitting the collected beam to the measuring module 400 by the focusing optical module 300 (S300), using the measuring module 400 (S400) to measure a signal using the transmitted beam, and analyzing the signal measured by the measuring module 400 using the analysis module 500.

In the irradiating the beam having the same NA size to the sample 1 by the illuminating optical module 200 (S200), the size of NA of the transmitted beam may be adjusted by adjusting a position of the aperture stop 240 disposed in the illuminating optical module 200.

Adjusting the amount (for example, area) of the beam transmitted by the field stop 220 disposed within the illuminating optical module 200 (S210) may be included.

In addition, linearly polarizing (for example, adjusting polarization components of) the beam with adjusted NA in the illuminating optical module 200 by the polarizer 270 and irradiating the linearly polarized beam to the sample 1 at a specific AOI (S220) may be included.

In S400, in the measuring the signal by the measuring module 400, a signal of a wide FOV may be detected. In S500, in the analyzing the signal measured by the measuring module 400 by the analysis module 500, optical properties such as reflectance and refractive index of the sample 1 and measurement values such as, for example, CD, overlay, thickness, and Mueller Matrix may be analyzed, but example embodiments are not limited thereto.

According to some example embodiments of image processing methods according to some inventive concepts, the beam (of, for example, white light) irradiated from the light source 110 may pass through the monochromator 120, and may be transmitted to the illuminating optical module 200 through an optical configuration such as, for example, an optic fiber, as monochromatic light of a specific wavelength.

Characteristics of the beam transmitted to the illuminating optical module 200 changes to a beam with an NA of the same size by the aperture stop 240 disposed within the illuminating optical module 200, and the beam with an NA of the same size may be incident on the wide area of the sample 1 with a specific polarization component while passing through the polarizer 270. In such a case, the beam incident on the sample 1 may have a specific wavelength, a specific polarization component, and the same NA in all parts of the FOV, depending on the adjustment in the Illuminating optical module 200 and the polarizer 270.

Next, the beam reflected and/or scattered from the sample 1 may be changed to have a specific polarization component through the analyzer 310 and then transmitted to the focusing optical module 300.

The beam may pass through a delay optic system, which may be included in the focusing optical module 300, and then be transmitted to the image sensor 410 of the measuring module 400, and the measuring module 400 may receive a signal of FOV and measure the signal.

Lastly, in the analysis module 500, an analysis process may be performed to analyze the structure and properties of the target sample.

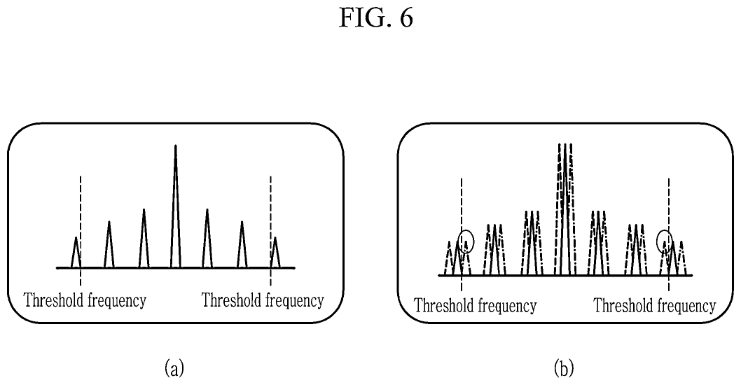

FIG. 6 is provided to describe the effect of an image system including an illuminating optical module according to some example embodiments.

FIG. 6, (a) and (b) illustrate that there may be a difference in a signal obtained within a threshold frequency depending on existence and/or size of an NA.

FIG. 6(a) shows a signal obtained in the threshold frequency when the NA is 0, and FIG. 6(b) shows a signal obtained in the threshold frequency when the NA is 0.06.

A beam transmitted from a conventional collimated light illuminating optical system shown in FIGS. 1(a) and (b) to the focusing optical system has a small or no NA, which corresponds to FIG. 6(a), and the image system 10 according to present inventive concepts may correspond to FIG. 6(b).

The focusing optical module 300 may, for example, only acquire signals within the limit NA, and accordingly there may a problem in that it cannot acquire signals with a high frequency component above the threshold frequency. Accordingly, in the illuminating optical module 200 according to some inventive concepts, as shown in FIG. 6(b), it is significant that the beam itself has a large NA, allowing the high-frequency components to fall within the threshold frequency of the focusing optical module 300.

In the illuminating optical module 200 according to some inventive concepts, the aperture stop 240 is disposed between the second lens 230 and the third lens 250 such that beams have the same NA in all parts of the FOV within the limit NA of the conventional collimated light illuminating optical system (Telecentricity), a broad range of frequencies can be generated (frequency broadening), and accordingly, high-frequency components are allowed to fall within the threshold frequency.

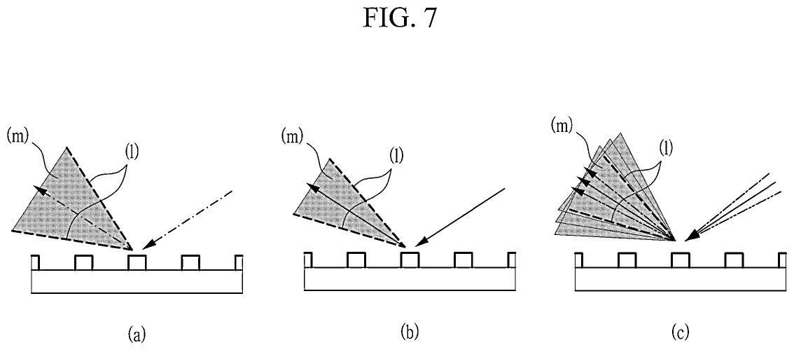

FIG. 7 to FIG. 9 illustrate the effects of the image system including the illuminating optical module according to some example embodiments.

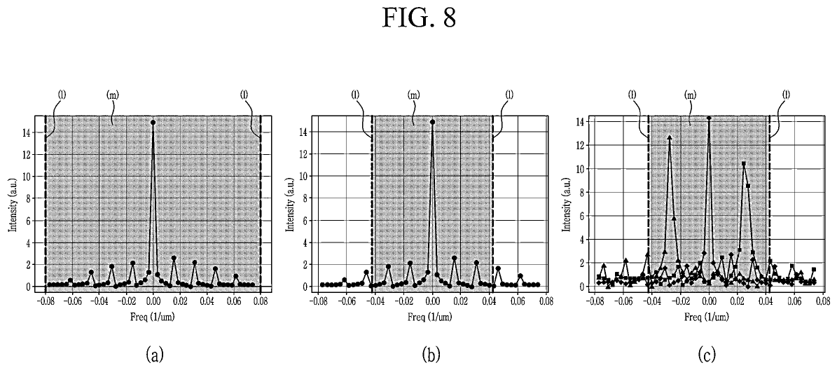

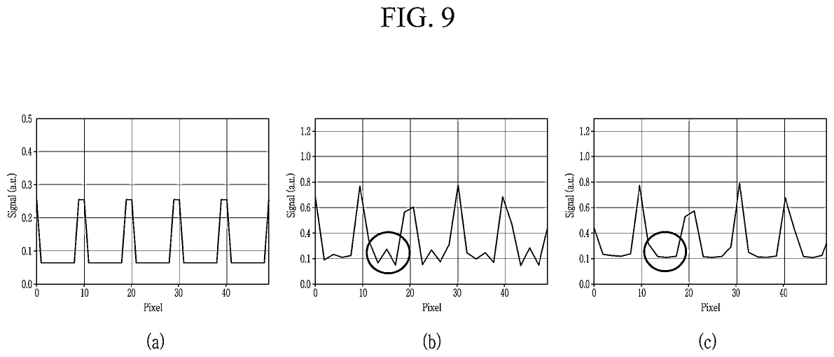

FIG. 7 shows a structural model of an object to be measured and the form in which a transmitted beam is reflected on an upper surface of the structural model, FIG. 8 illustrates a spatial frequency of the reflected beam, and FIG. 9 shows a result of measuring the structural model of FIG. 7.

In addition, in FIG. 7 to FIG. 9, (a) shows a theoretical value in the case where a beam without NA measures the above structural model, (b) shows an actual measurement value, not the theory, when a beam without NA measures the above structural model, and (c) shows a measurement value when a beam with NA measures the above structural model by the illuminating optical module 200 according to present inventive concepts.

Referring to FIGS. 7(a), (b), and (c), a case where a beam is irradiated in the same direction to the same structural model with a cell and core is illustrated. In each drawing, (1) denotes a threshold frequency and (m) denotes a region of a spatial frequency where measurement is possible due to a limit of the focusing optical module 300.

FIG. 7(a) depicts a case in which the transmitted beam has no NA (for example, an NA with a value of 0), and the beam transmitted to the structure model is reflected, and the beam may be positioned in a range of the threshold frequency (1) and the spatial frequency region (m) where measurement is possible.

FIG. 7(b) depicts a case in which the transmitted beam has no NA as shown in FIG. 7(a), and beam may be positioned in a range of the threshold frequency (1) and the spatial frequency region (m) where measurement is possible.

However, unlike the spatial frequency region (m) and the range of the threshold frequency (I) that are measurable in theoretical values in FIG. 7(a), the range of the measurable spatial frequency region (m) and the threshold frequency (1) in FIG. 7(b) measured through actual experiments is narrowed.

FIG. 7(c) shows the range of the threshold frequency (I) and the measurable spatial frequency region (m) when the beam with NA is transmitted to the structure model through the illuminating optical module 200 according to some inventive concepts. The threshold frequency (I) shown in FIG. 7(c) is the same as the threshold frequency (1) shown in FIG. 7(b), but in FIG. 7(c), high-frequency components are further included within the range of the threshold frequency (1).

FIG. 8(a) shows a region (m) of a spatial frequency according to FIG. 7(a) and FIG. 8(b) shows a region (m) of a spatial frequency according to FIG. 7(b), and as in FIGS. 7(a) and (b), it can be confirmed that the spatial frequency region (m) is narrower in the actual experimental measurement value than in the theoretical value.

FIG. 8(c) shows the spatial frequency region (m) according to FIG. 7(c), and it is the same as the region (m) of the spatial frequency of FIG. 8(b). However, there is a difference in that more high-frequency components are included within the spatial frequency region (m).

Referring to FIGS. 9(a) and (b), which is the result of measuring each structural model under the conditions of FIGS. 7(a) and (b), the result should be the same as in FIG. 9(a) according to simulation based on theory, but as shown in FIG. 9(b), the result from the actual experiment is different from the theoretical value. In addition, the result shown in FIG. 9(c) does not match the theoretical value according to FIG. 9(a), but is closer to the theoretical value than the result measured in FIG. 9(b).

The above may signify that a stable signal value closer to the actual structural model can be measured when measuring the structure by transmitting a beam with NA to the sample 1 through the illuminating optical module 200 according to some inventive concepts (FIG. 9(c)), and measuring the structure by transmitting a beam without NA to the sample 1 through the conventional collimated light illuminating optical system (FIG. 9(b)).

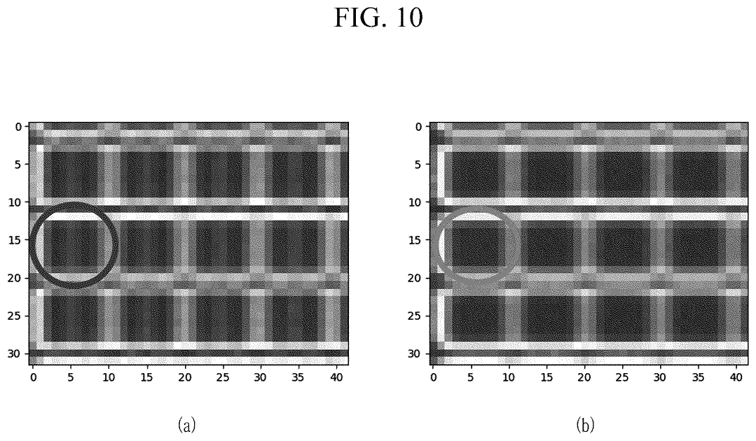

FIG. 10 illustrates of the effect of the image system including the illuminating optical module according to an embodiment.

FIG. 10(a) shows a result of measuring cell and core structures as shown in FIG. 7(b) using the conventional collimated illuminating optical system of FIG. 1, and FIG. 10(b) shows a result of measuring a structure shown in FIG. 7(c) using the illuminating optical module 200 according to some inventive concepts.

In the case of using the conventional collimated light illuminating optical system, as shown in FIG. 10(a), it can be shown that a cell signal around the core is not stable. This is because due to low optical resolution, the surrounding core signal affects the cell signal, reducing signal uniformity.

However, as shown in FIG. 10(b), when the illuminating optical module 200 according to some inventive concepts is used, the reliability of the measured signal is high. This is because, unlike as in FIG. 10(a), a beam with a large NA can be irradiated to the large area of the sample 1, thereby increasing the optical resolution and improving the uniformity of the signal.

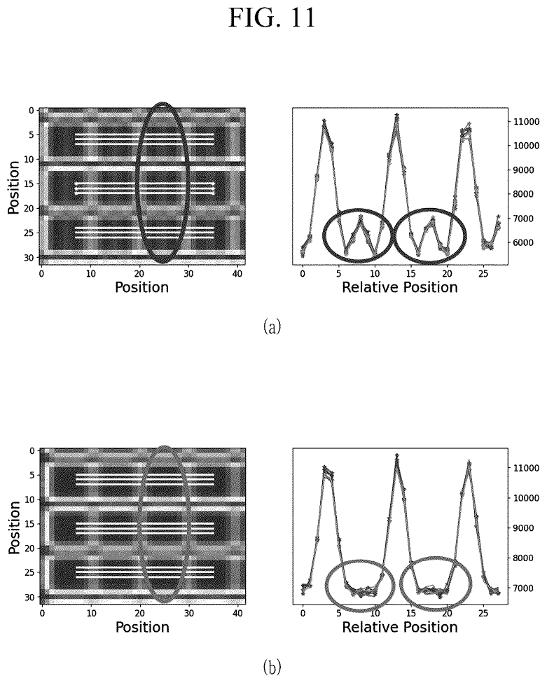

FIG. 11 illustrates of the effect of the image system including the illuminating optical module according to some example embodiments.

FIG. 11 is illustrates that the coherence effect is reduced in the case that a structure with cells and cores is measured with the beam having NA through the illuminating optical module 200 according to present inventive concepts compared to the case in which the structure is measured using the conventional collimated illuminating optical system.

In FIGS. 11(a) and (b), in the respective drawings shown on the left, cells are arranged in three rows and each row has three white lines. The graph shown on the right of each drawing shows a signal of the white lines shown in the left drawing, and shows signals measured in the cell between the cores.

FIG. 11(a) depicts a case using a conventional collimated light illuminating optical system, and referring to the graph on the right, the signal representing each cell is influenced by the core positioned around at the periphery, and thus it may be confirmed that extraction of a unique signal of each cell is impossible.

In contrast, FIG. 11(b) is a case of using the illuminating optical module 200 according to some inventive concepts, and it can be confirmed that it is relatively possible to extract a unique signal for a desired cell, regardless of the surrounding structure of the cell.

In other words, when using the illuminating optical module 200 according to present inventive concepts, it can be confirmed that is possible to acquire the signal of the desired cell regardless of an edge structure such as the core positioned around the cell, and the uniformity of the cell internal signal is also improved.

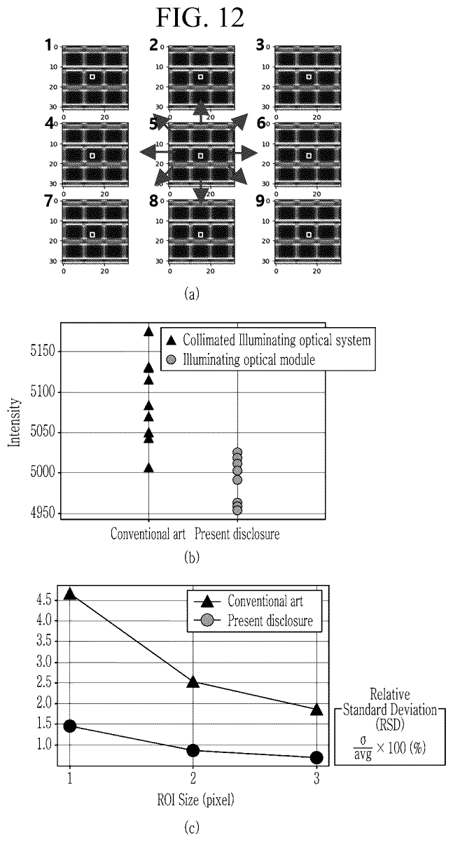

FIG. 12 illustrates of the effect of the image system including the illuminating optical module according to an embodiment.

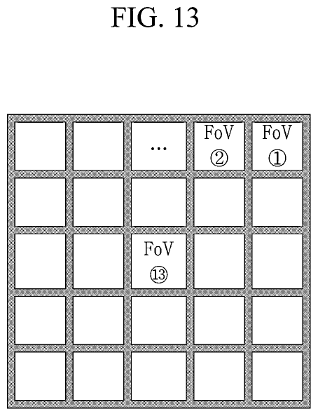

FIG. 12 and FIG. 13 are provided for description of the effect of ensuring robustness in a signal difference due to a region of interest (ROI) error used in the structural measurement in the case of the structural measurement using the illuminating optical module 200 according to some inventive concepts.

FIG. 12(a) shows a case where eight different ROIs are selected for each pixel using a screen placed in a center as a reference.

FIG. 12(b) shows that there is a difference in the signal generated depending on the position selected by each ROI as shown in FIG. 12(a).

When using a conventional collimated light illuminating optical system, a range in which the signal is generated is wide depending on the selected position of the ROI, whereas when using the illuminating optical module 200 according to some inventive concepts, the range in which the signal is generated is narrowed.

FIG. 12(c) illustrates a change in signal according to the size of the ROI in the cell, and it can be confirmed that the change in signal (relative standard deviation, RSD) according to the ROI size is small when using the illuminating optical module 200 according to some inventive concepts compared to using the conventional collimated light illuminating optical system,

Although it is not illustrated, when using the illuminating optical module 200 according to present inventive concepts, even in a case where the size of ROI is 16 or more, which causes the RSD to be lower than about 0.2%, ROI robustness is secured.

In addition, the ROI robustness is secured in all wavelength regions, which has the effect of improving the repeatability of measurements and uniformity of measured values.

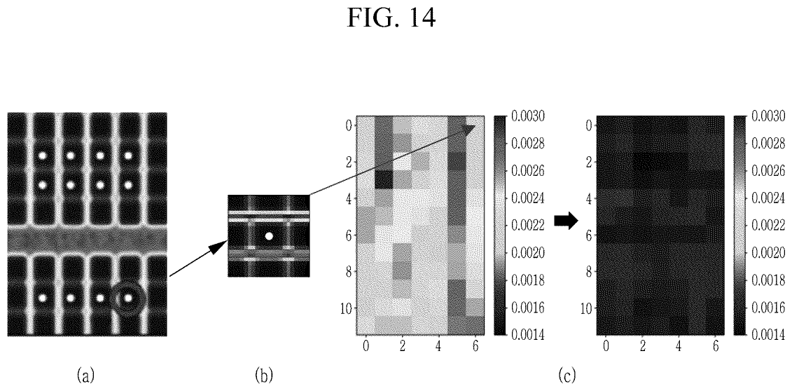

FIG. 13 and FIG. 14 are provided for description of the effect of the image system including the illuminating optical module according to an embodiment.

FIG. 13 and FIG. 14 are provided to describe the effect of improvement of in-field of view uniformity (IFU) of a structure measurement value.

The IFU implies the degree of improvement in uniformity of measured values when measuring the same part of the sample 1 with a different FOV. In other words, the IFU implies the degree to which each FOV represents the same value.

FIG. 13 shows the sample 1 divided into a plurality of FOVs, and FIG. 14(a) is an enlarged view of a part of one of the plurality of FOVs in FIG. 13.

In FIG. 14(a), the plurality of ROIs are displayed at each point, and FIG. 14(b) extracts the average of one ROI.

FIG. 14(c) shows IFU components of an evaluation index (Mueller Matrix) extracted targeting FIG. 14(b), and the drawing shown on the left shows a case using a conventional collimated light illuminating optical system and the drawing shown on the right shows a case using the illuminating optical module 200 according to some inventive concepts.

Comparing the drawings of (a), (b), and (c) of FIG. 14, compared to conventional art, it can be confirmed that IFU value of cells with large structures such as edges and the like at the periphery are improved in structural measurement using image system 10 according to present inventive concepts.

In addition, it is possible to remove the Term of the measurement equipment (for example, dependence on specific measurement equipment) when measuring the structure by improving the overall IFU value, and Tool to Tool matching can be easily assured through the equipment Term removal.

Although the example embodiments of inventive concepts have been described in detail above, the scope of inventive concepts is not limited thereto, and various modifications and improvements of a person of ordinary skill in the art using the inventive concepts as in in the following claims also fall within the spirit and scope of inventive concepts.

Terms, such as first, second, etc. may be used herein to describe various elements, but these elements should not be limited by these terms. The above terms are used only for the purpose of distinguishing one component from another. For example, a first element may be termed a second element, and, similarly, a second element may be termed a first element, without departing from the scope of the present disclosure.

Singular expressions may include plural expressions unless the context clearly indicates otherwise. Terms, such as “include” or “has” may be interpreted as adding features, numbers, steps, operations, components, parts, or combinations thereof described in the specification.

It will be understood that when an element or layer is referred to as being “on”, “connected to”, “coupled to”, “attached to”, or “in contact with” another element or layer, it can be directly on, connected to, coupled to, attached to, or in contact with the other element or layer, or intervening elements or layers may be present. In contrast, when an element is referred to as being “directly on”, “directly connected to”, “directly coupled to”, “directly attached to”, or “in direct contact with” another element or layer, there are no intervening elements or layers present. As used herein, the term “and/or” includes any and all combinations of one or more of the associated listed items.

When the terms “about” or “substantially” are used in this specification in connection with a numerical value, it is intended that the associated numerical value includes a manufacturing or operational tolerance (e.g., ±10%) around the stated numerical value. Moreover, when the words “generally” and “substantially” are used in connection with geometric shapes, it is intended that precision of the geometric shape is not required but that latitude for the shape is within the scope of the disclosure. Further, regardless of whether numerical values or shapes are modified as “about” or “substantially,” it will be understood that these values and shapes should be construed as including a manufacturing or operational tolerance (e.g., ±10%) around the stated numerical values or shapes. When ranges are specified, the range includes all values therebetween such as increments of 0.1%.

It will be understood that elements and/or properties thereof may be recited herein as being “the same” or “equal” as other elements, and it will be further understood that elements and/or properties thereof recited herein as being “identical” to, “the same” as, or “equal” to other elements may be “identical” to, “the same” as, or “equal” to or “substantially identical” to, “substantially the same” as or “substantially equal” to the other elements and/or properties thereof. Elements and/or properties thereof that are “substantially identical” to, “substantially the same” as or “substantially equal” to other elements and/or properties thereof will be understood to include elements and/or properties thereof that are identical to, the same as, or equal to the other elements and/or properties thereof within manufacturing tolerances and/or material tolerances. Elements and/or properties thereof that are identical or substantially identical to and/or the same or substantially the same as other elements and/or properties thereof may be structurally the same or substantially the same, functionally the same or substantially the same, and/or compositionally the same or substantially the same.

Spatially relative terms (e.g., “beneath,” “below,” “lower,” “above,” “upper,” and the like) may be used herein for ease of description to describe one element or feature's relationship to another element(s) or feature(s) as illustrated in the figures. It should be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” may encompass both an orientation of above and below. Features may be otherwise oriented (rotated 90 degrees or at other orientations) and the spatially relative descriptors used herein interpreted accordingly.

Any or all of the elements described with reference to a drawing may communicate with any or all other elements described with reference to the same drawing. For example, in, for example, at least FIGS. 3 and 5, any element may engage in one-way and/or two-way and/or communication with any or all other elements, to transfer and/or exchange and/or receive information such as but not limited to data and/or commands, in a manner such as in a serial and/or parallel manner. The information may be in encoded various formats, such as in an analog format and/or in a digital format.

One or more of the elements disclosed above may include or be implemented in one or more processing circuitries such as hardware including logic circuits; a hardware/software combination such as a processor executing software; or a combination thereof. For example, the processing circuitries more specifically may include, but is not limited to, a central processing unit (CPU), an arithmetic logic unit (ALU), a digital signal processor, a microcomputer, a field programmable gate array (FGPA), a System-on-Chip (SoC), a programmable logic unit, a microprocessor, application-specific integrated circuit (ASIC), etc.

What is claimed is:

1. An imaging system including an illuminating optical module configured to transmit a beam irradiated from a light source to a sample, wherein the illuminating optical module comprises:
a first lens configured to receive a beam from a light source module;
a second lens configured to receive the beam from the first lens;
a field stop between the first lens and the second lens and configured to adjust an amount of the beam transmitted to the second lens;
a third lens configured to transmit the beam transmitted from the second lens to a sample; and
an aperture stop in a path of the beam and between the second lens and the third lens, the aperture stop configured to adjust a size of a numerical aperture (NA),
wherein the aperture stop is configured to make the beam transmitted to the sample have a same NA in all parts of a field of view (FOV).

2. The imaging system of claim 1, wherein:
the illuminating optical module comprises
an optic fiber configured to collect the beam transmitted from the light source module and to transmit the collected beam; and
a collimating lens configured to change the beam transmitted from the optic fiber into a collimated beam.

3. The imaging system of claim 2, further including a diffusion portion configured to diffuse the beam transmitted from the collimating lens and to transmit the diffused beam to the first lens.

4. The imaging system of claim 3, wherein
the diffusion portion comprises at least one of a diffuser and a grating.

5. The imaging system of claim 1, wherein:
the illuminating optical module comprises a polarizer configured to polarize the beam transmitted by the third lens,
wherein the polarizer is configured to linearly polarize the beam and to irradiate the linearly polarized beam to the sample with a specific angle of incidence (AOI).

6. The imaging system of claim 5, wherein
the AOI is within a range of 0 to 90 degrees.

7. The imaging system 1, wherein:
the illuminating optical module comprises a beam monitoring portion configured to monitor the path of the beam.

8. The imaging system of claim 1, wherein:
the illuminating optical module comprises a mirror configured to change the path of the beam transmitted by the second lens.

9. An image system, comprising:
a light source module configured to irradiate a beam;
an illuminating optical module including a field stop, an aperture stop, and a plurality of lenses, and configured to make the beam irradiated from the light source module have the same numerical aperture (NA) in all parts of a field of view (FOV) and to irradiate the beam to a sample, the sample configured to reflect to the beam irradiated thereto; and
a focusing optical module configured to collect the beam reflected by the sample and to transmit the collected beam to a measuring module; wherein
the measuring module is configured to measure a signal by using the beam transmitted from the focusing optical module.

10. The image system of claim 9, further including
a field stop between a first lens and a second lens of the plurality of lenses and configured to adjust an amount of the irradiated beam.

11. The image system of claim 10, further including
an aperture stop between the second lens and a third lens at a focal distance of the second lens and the third lens.

12. The image system of claim 9, wherein
the light source module further comprises a monochromator configured to filter the beam irradiated from the light source to a desired wavelength, convert the beam into a monochromatic light, and make monochromatic light incident on the illuminating optical module.

13. The image system of claim 9, wherein:
the beam irradiated from the light source module is white light.

14. The image system of claim 9, further comprising: an analyzer between the sample and the focusing optical module and configured to change the beam reflected from the sample to have a specific linear polarization property.

15. The image system of claim 9, wherein
the measuring module comprises an image sensor.

16. The image system of claim 9, further comprising: an analysis module configured to analyze the signal measured by the measuring module.

17. The imaging system of claim 9, wherein:
the illuminating optical module comprises
an optic fiber configured to collect the beam transmitted from the light source module and to transmit the collected beam; and
a collimating lens configured to change the beam transmitted from the optic fiber into a collimated beam.

18. The imaging system of claim 17, further including a diffusion portion configured to diffuse the beam transmitted from the collimating lens and to transmit the diffused beam to the first lens.

19. The imaging system of claim 9, wherein:
the illuminating optical module comprises a polarizer configured to polarize the beam transmitted by the third lens,
wherein the polarizer is configured to linearly polarize the beam and to irradiate the linearly polarized beam to the sample with a specific angle of incidence (AOI).

20. The imaging system of claim 19, wherein
the AOI is within a range of 0 to 90 degrees.
